(19) United States
(12) Patent Application Publication
(10) Pub. No.: US 2014/0338927 A1
(43) Pub. Date: Nov. 20, 2014

(54) MODULAR, PERMANENTLY INSTALLED TUNNEL FIRE PROTECTION SYSTEM

(71) Applicant: VID Fire-Kill ApS, Svendborg (DK)

(72) Inventor: Carsten Palle, Svendborg (DK)

(21) Appl. No.: 14/366,215

(22) PCT Filed: Dec. 19, 2012
(86) PCT No.: PCT/DK2012/050481

§ 371 Date: Jun. 17, 2014

(30) Foreign Application Priority Data
Dec. 19, 2011 (DK) PA 2011 00982

(51) Int. Cl. A62C 35/60; A62C 35/68

(52) U.S. Cl. CPC A62C 35/60; A62C 35/68
USPC 169/16

(57) ABSTRACT

The invention relates to an interconnected module sectionized fire extinguishing system for fire protection in elongated cavities, which is characterized by consisting, in the cavity, of a number of intercoupled section modules in the longitudinal direction of the cavity, said section modules being characterized by being provided with a control valve connecting a water mist nozzle system to water supply pipe with an applied water pressure of 4 bars to 16 bars, and where, in case of fire in the cavity, section modules distribute low-pressure water mist in the form of finely divided droplets in the volume of the cavity in which there is a fire and in the area of coverage of a section module on both sides of the area of fire, and where the distributed water drops are characterized by 90% of the volume of water being constituted by water drops with a drop diameter of less than 0.001 m.

The invention relates to an interconnected module sectionized fire extinguishing system for fire protection in elongated cavities, which is characterized by consisting of intercoupled system modules installed as section modules, where, in case of fire, low-pressure water mist distributing nozzles are applied with a water pressure of 4 bars to 16 bars on their inlet ports, whereby the nozzle system distributes a water mist spray in the cavity volume where and round the area to which a fire has been localized, the spray being defined such that 90% of the distributed water is distributed in water drops with drop diameters of less than 0.001 m.

1. The Field of Use of the Invention

The invention relates to a water-based extinguishing installation for fire protection of elongated cavities with high fire loads, including infrastructure tunnels, cable tunnels, and car decks in ferries etc.

2. The Prior Art

It is known technology to install sprinkler systems for fire protection of elongated cavities with high fire loads, such as for example car decks on ferries, and tunnels.

It is known technology to install sprinkler systems for fire protection of car decks on ferries. The sprinklers may be individually automatically activated by the heat from a fire or be activated in groups by activation of a group valve. It is common to the sprinkler systems that it is aimed at to thereby distribute the extinguishing water from the sprinkler heads in drops which are as big as possible in order to impart the water drops with a momentum enabling them to penetrate through the thermals of the fire so as to get to the burning fuel and wet it and hereby to control and extinguish the fire by cooling the fuel and reducing the fire pyrolysis processes producing the inflammable gases that keep the fire going and supply the fuel to the fire oxidation processes taking place in the flames.

The sprinkler technology described above calls for the extinguishing system to deliver relatively high water densities and consequently has a high water consumption in order to be able to effectively fight fires in elongated cavities with high fire loads. In respect of infrastructure tunnels, this typically entails demands that sprinkler systems can deliver water densities of 5-20 litres of water per m².

It is a problem with the known sprinkler technology that the required water densities get very high, which entails that water supply installations, water drainage installations, and pipe installations get very large and consequently space demanding and expensive.

A known method of reducing the water consumption from sprinkler installations is to install high-pressure water mist systems for fire protection of elongated cavities. These systems are characterized in that water, at high water pressures, is passed onto water mist nozzles which, at water pressures of typically 50 bars to 200 bars, distribute the water under the nozzles in the form of water droplets at high velocities. The many water droplets and their high velocities create strong ventilation of an atmosphere with high water density and consequently strong inertia pressing the pyrolysis gases away from the fuel surfaces, whereby the distance between the fuel surface and the heat development of the fire is increased, which entails a reduction in the radiant heating of the fuel, whereby the pyrolysis gas development of the fire is reduced and the fire restricted, controlled, and perhaps put out with low water densities.

A disadvantage of high-pressure water mist systems is the demand of the water mist nozzles for very high water supply pressures. This places severe demands on pump design, pipe systems, and power supply to the systems. Furthermore, the high nozzle pressures entail that nozzles have very small nozzle bores, which places severe demands on water filtration and water qualities, and which causes the systems to be very sensitive and vulnerable to errors and cloggings and consequently very expensive and maintenance dependent.

Another known technique for limiting the fluid supply flow is to divide the elongated cavity into an interconnected chain of fire zones, each of which is fire protected by a local fire protection system which is activated in case of a fire in the protection zone.

Hereby the cavity area in which the extinguishing water is to be distributed is restricted so as to be the area of the fire protection zone.

It is a problem in this respect that in many elongated cavities, such as for example infrastructure tunnels, there are often longitudinal ventilation and almost contiguous combustible materials, e.g. trains, cars, lorries, or cables in cable tunnels etc. The ventilation and the contiguous combustible materials .hereby constitute danger that fires in elongated cavities could spread from one fire protection zone to other fire protection zones.

It has been sought to solve the last-mentioned problem in that, in case of fire in a fire protection zone, several local fire protection systems are triggered, typically the local fire protection system which protects the zone in which the fire was localized as well as one of or both of the local fire protection systems on either side of the zone with the fire.

It is a major problem as regards fire protection zone sectionized fire protection systems for elongated cavities that these often get very complicated and very vulnerable to incorrect mounting, and that they are slow to install and very maintenance demanding. This problem is due not least to the systems often being characterized by comprising a combination of hydraulic and electric systems and circuits with different platforms which are intercoupled via a common control for the entire installation in order to constitute an interconnected fire protection system which includes intercoupled systems for detecting and establishing the localities of the fire relatively to the fire zones of the cavity, activation of relevant local extinguishing systems, alarms, monitoring of the aggregate system, activation of pumps and valves etc.

### What Special is Obtained by the Invention vis-à-vis the Prior Art

It is the object of the present invention to provide a more expedient solution to the above problems.

### The New Technical Means

The invention relates to an interconnected module sectionized fire extinguishing system for fire protection in elongated cavities, which is characterized in that it consists of intercoupled system modules installed as section modules where, in case of fire, low-pressure water mist distributing nozzles are applied with a water pressure of 4 bars to 16 bars on their inlet ports, whereby the nozzle system distributes a water mist spray in the cavity volume where or round the area to which a fire has been localized, the spray being defined such that 90% of the distributed water is distributed in water drops with drop diameters of less than 0.001 m.

### The Technical Effect

The invention functions in that system modules are installed and inter-coupled so as to constitute an interconnected fire protection system extending through an elongated cavity.

In case of fire in the elongated cavity, the local zone valves of the system are activated, which control the water supply from the water supply pipes of the system to nozzle with low-pressure water mist nozzles that are installed in the area at and round the locality of the fire.

Water hereby flows from supply pipes via the open section valve or valves into the connected nozzle pipes and via these to the open water mist nozzles from where the water is distributed in and round the area of the fire in the form of a water mist spray, 90% of the water being distributed in water drops with drop diameters of less than 0.001 m and being distributed at relatively low velocities.

The water in the water drops evaporates when they get into contact with the heat from the fire.

The evaporation heat of the water entails that the atmosphere round the fire is cooled, whereby the thermal gas expansion of the atmosphere round the fire is reduced and the cooled combustion gases and the water vapour formed hereby envelope the fire with a relatively stagnant low-oxygen atmosphere which smothers and reduces the fire.

In connection with full-scale fire tests carried out in infrastructure road tunnel the invention has turned out to be able to control and fight fires in oil ponds and solid fuels with potential heat ratings of up to 100 MW, which corresponds to the thermal output from a fully developed fire in large, burning lorries.

### Multiple Claims

A variant of the invention is characterized by the installation throughout the elongated cavity being constituted by an interconnected array of intercoupled system modules in the longitudinal direction of the cavity. The variant of the invention is characterized in that the system modules together constitute an interconnected supply pipe to which, via section valves, sectionized nozzle pipes with water mist nozzles mounted thereon are coupled.

By the invention it is achieved that the fire protection system in the elongated cavity can be made in ready-mounted modules which can be installed rapidly in the cavity and which can be delivered ready-mounted and tested for installation in the cavity, whereby the system mounting can be made more efficient, risk of introduction of impurities in pipes and erroneous mounting is reduced, and system testing after system mounting can be reduced.

A variant of the invention is characterized in that nozzle pipes are made of thin-walled material with a material thickness of 1-3 mm, inside thread connections for the water mist nozzles of the system being provided on the inside of the pipe.

The technical effect of the variant of the invention is that the invention can be carried out with nozzle pipes without the use of T-fittings for connecting water mist nozzles to nozzle pipes. Another effect of the variant of the invention is moreover that water mist nozzles can be installed on the bottom side of nozzle pipes, the inlet port of the nozzles at the same time being lifted up above the inside bottom side of the pipe, whereby risk of cloggings of nozzle openings due to assemblies of dust in nozzle pipes is reduced.

A variant of the invention is characterized in that water mist nozzles are positioned offset from each other and at one: or several angles relatively to the surface of the nozzle pipe.

The technical effect of the variant of the invention is that by installing nozzles at different angles relatively to the nozzle pipe, a larger area of coverage is obtained per nozzle pipe, and by installing nozzles offset from each other in the longitudinal direction of the nozzle pipe it is obtained that nozzle sprays do not affect their respective areas of coverage.

A variant of the invention is characterized in that fire protection modules are installed in elongated cavities, the modules consisting of sectionized nozzle pipe systems with low-pressure water mist nozzles which via section valves are coupled to one or several common water supply pipes, and where hydrant couplings for water for fire hoses are mounted on water supply pipes, optionally via a pressure reduction valve.

The technical effect of the variant of the invention is that low-pressure water mist system and hydrant system for fire fighting in elongated cavities can be supplied via the same water supply system.

A variant of the invention is characterized in that nozzle pipes in the elongated cavity are mounted on the cavity walls and that low-pressure water mist nozzles with horizontal spray are mounted thereon.

The technical effect of the variant of the invention is that water is distributed horizontally from the cavity walls into the fire and the cavity round the fire. Hereby it is achieved that the water mist does not have to penetrate through the fire thermals in order to get into the flames, which entails rapid evaporation of the water mist from the water mist nozzles and that installation of nozzle pipes and water mist nozzles in the cavity ceilings is avoided, which often facilitates service to the installation and reduces cavity laydown time in connection with service. A variant of the invention is characterized in that the system modules consist of hydraulic and electric components which, when the system modules are installed and mounted in the cavity, constitute a fully fire protected installation, where, for each fire section, there is provided a two-stage electronic fire announcing system, an active low-pressure water mist based extinguishing system with section activation valve, a two-stage fire detecting system with flame announcer and temperature monitoring, as well as section control system with monitoring of electric circuits and connections and data connections for common bus for system monitoring and manual activation of hydraulic system sections.

The technical effect of the variant of the invention is that up to ten meter long modules two and two constitute the aggregate system for a protection zone in an elongated cavity. The modules are delivered fully mounted and tested from the producer. They are mounted in the cavity and flanged together, whereby the aggregate system constitutes a totally sectionized extinguishing system in the cavity. All electric connections are drawn in the assembled system modules and can only be connected in one way. If this is not done, an addressed error alarm is automatically given off by the local system panels premounted on the system modules. The variant of the invention hereby constitutes a fully active fire protection system with active hydraulic fire extinguishing capacity and rapid electronic fire announcing capacity, with only one platform, which makes the system rapid and safe to install, and which requires a minimum of maintenance after installation and commissioning. A variant of the above variant of the invention is characterized in that the fire announcing system for each fire protection section contains at least one flame announcer with built-in time delay for the fire alarm transfer.

The technical effect of the variant of the invention is that each flame announcer monitors an area in the cavity as to fires. The ultraviolet radiation from the fire makes the flame announcers react rapidly to a fire, and the flame announcers only send on an activation signal to the water mist section control unit if the fire remained in the monitoring area of the flame announcer for the entire preset delay time. This ensures that the water mist system in the cavity cannot get activated by short-duration fires and fires travelling through the cavity. The last-mentioned is of importance in particular in connection with active fire protection of infrastructure tunnels where moving vehicles on fire can drive out of the tunnel without causing a water mist spray activation in the tunnel. A variant of the invention is characterized in that the hydraulic fire extinguishing system consists of sectionized nozzle pipe systems with low-pressure water mist nozzles mounted thereon, and where the water connection for each nozzle section is passed out of the fire protected cavity, and where the water supply is provided with a hose connection.

The technical effect of the variant of the invention is that in case of a fire in the elongated cavity, the fire brigade couples its water supply onto the nozzle pipe hose connection corresponding with the nozzle section installed in or in the area round the fire, whereby water mist spray from the nozzle system controls the fire and firefighters relatively safely can enter the cavity and carry out their rescue mission.

### LIST OF FIGURES

FIG. 1: Shows an example of an elongated cavity, in the form of a tunnel, which consists of an interconnected chain of fire sections.

FIG. 2: Shows an example of an elongated cavity, in the form of a tunnel, in which an example of the invention is installed and actively fights a fire in a tunnel fire protection zone;

FIG. 3: Shows an example of the invention showing two fully mounted tunnel cavity modules which together constitute a fire protection system for a whole tunnel fire section.

FIG. 4: Shows an example of the invention showing an example in which nozzle pipes are installed on the wall in a tunnel and where a sectionized water mist system shares water supply and water supply pipes with a hydrant system.

FIG. 5: Shows an example of the invention showing a sectionized water mist nozzle pipe system installed in the ceiling of a tunnel, and where the water supply for the individual water mist nozzle pipe sections is a hose connection passed out from the fire protected cavity.

FIG. 6: Shows an example of a low-pressure water mist nozzle operating according to the centrifugal principle.

FIG. 7: Shows an example of nozzle pipes with low-pressure water mist nozzle mounted thereon, showing that nozzle pipes are provided with an inside threaded portion for mounting of low-pressure water mist nozzles.

FIG. 8: Shows an example of the invention showing two fully mounted tunnel cavity modules which together constitute a fire protection system for a tunnel fire section, including pipes and components for active hydraulic fire extinguishing, and control sensors for detecting fires in the fire section.

### EXEMPLARY EMBODIMENTS

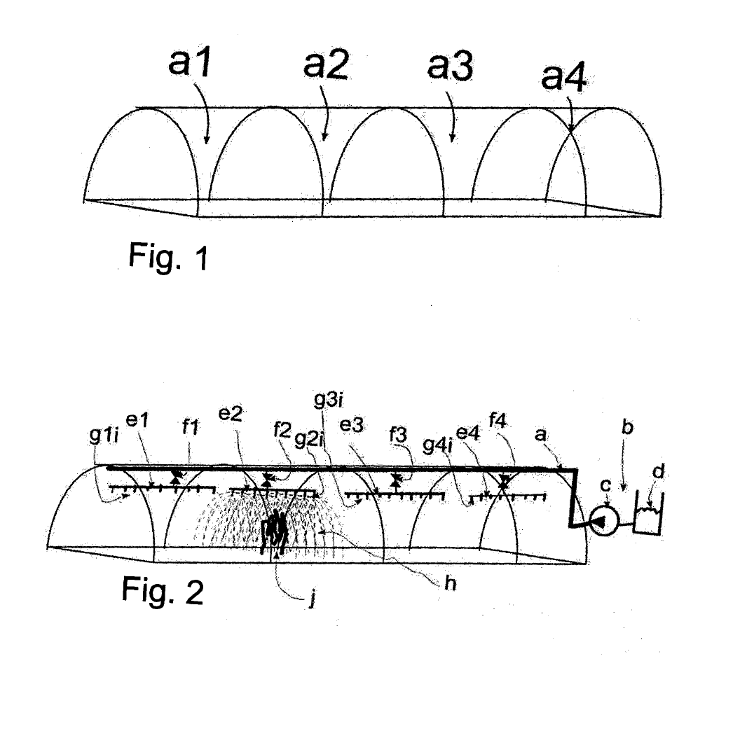

FIG. 1 shows a typical example of an elongated cavity in the form of a tunnel tube consisting of an interconnected line of fictive fire zones (a1, a2, a3, a4).

FIG. 2 shows an example of the invention installed in an elongated cavity as outlined in FIG. 1. The invention in the example is an interconnected low-pressure water mist based extinguishing system consisting of a connected water supply pipe (a) installed centrally in the cavity ceiling and being hydraulically coupled to a water supply system (b) in the form of a pump (c) and a water reservoir (d), which may also merely be a water supply pipe. To the water supply pipe (a) there is, for each of the fictive fire zones of the tunnel cavity, coupled a zone valve (f) which connects the water supply pipe (a) to a nozzle pipe system (e) with mounted on low-pressure water mist nozzles (g), which are installed so as to provide water mist coverage in the entire fire zone volume in which the nozzle pipe system is installed. In case a fire (j) breaks out in a fire zone (2), the zone valve (f2) is activated, whereafter the valve is opened and allows water under pressure to flow from the water supply pipe via the zone valve into the nozzle pipe system (e2) from where the water flows out to the low-pressure water mist nozzles (g2) from where the water is distributed as a mist of water droplets in and round the area of fire where the water evaporates and thereby cools the atmosphere round the area of fire, whereby the thermal gas expansion is reduced and the vapour formed and the gases from the fire form a relatively stagnant low-oxygen atmosphere enveloping and smothering the fire.

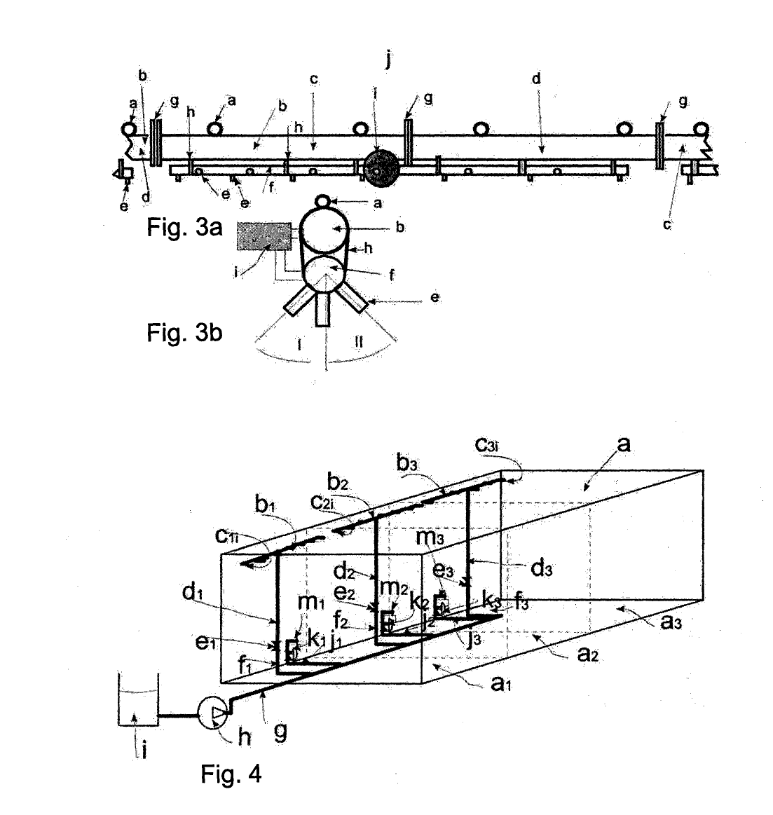

FIG. 3 shows an embodiment of the invention showing two mounted hydraulic tunnel fire protection modules, an active tunnel module (c), and a spacer tunnel module (d), which together constitute the extinguishing system as installed for fire protection of a fictive tunnel protection zone shown in FIG. 1.

The active tunnel module (c) consists of a water supply pipe section (b), the ends of which are terminated by flanges (g) or other kind of pipe connection. An electrically activated zone valve (i) is hydraulically coupled to the water supply pipe (b), the outlet port of the valve being hydraulically coupled to a T-connection on an underlying nozzle pipe (F) to which low-pressure water mist nozzles (e) are coupled. The nozzle pipe (f) consists of nozzle pipes mounted on an active tunnel module and nozzle pipes mounted on spacer tunnel module, which are coupled together and closed at either end, and the total length of which corresponds to the tunnel length of the tunnel fire section.

In case of a fire in the corresponding tunnel fire zone or a neighbouring fire zone thereof, the water supply of the system is activated whereby a water pressure of up to 16 bars arises in the aggregate supply pipe (b) extending throughout the entire length of the cavity. The zone valve (i) is applied with an activation signal, whereby the valve opens and allows water to flow via the zone valve (1) from the supply pipe (b) into the aggregate nozzle pipe (f) from where it is distributed in the volume of the cavity section in the form of a water mist spray in the form of droplets, a minimum of 90% of the water being distributed in droplets with a diameter of less than 0.001 m.

FIG. 3a shows that the water mist nozzles (e) are disposed axially offset on the nozzle pipe (f); FIG. 3b shows that the water mist nozzles (e) are disposed polarly angularly offset on the lower half of the nozzle pipe (f). Hereby it is achieved that air flows from water mist spray from the individual nozzles do not affect each other, whereby the distribution of the water mist in the cavity volume can be made homogeneous in substantial volume.

FIG. 4 shows a fire section (a1, a2, a3) sectionized cavity in which a variant of the invention is installed. The variant of the invention is characterized in that water mist nozzles (c) are installed in sectionized nozzle pipes (b) positioned on the cavity wall so that the water mist nozzles deliver a water mist spray horizontally into the cavity volume, and that the sectionized nozzle pipes (b1, b2, b3), via zone activation valves (f1, f2, f3), are coupled to a common water supply pipe (g), which may be positioned outside the protected volume, and to which there are coupled fire hydrant connections (m1, m2, m3) being positioned in the fire protected cavity, and the supply pipe is coupled to a water supply system with pump (h) and water reservoir (i), which could optionally also be a water supply pipe.

In case of a fire in one of the fire sections (a1, a2, a3), the pump system (h) is activated, whereby the water supply pipe (g) is pressurized with a water pressure. The zone valves which control the water supply to nozzle pipes in the fire section with fire and optionally the neighbouring fire sections of that section are activated. Hereby zone valves (e) are opened, whereafter water flows from the pressurized common water supply pipe (g) via the open zone valves and via riser pipes (d) to the nozzle pipes (b) in the activated fire zones and from there to the water mist nozzles (c), which distribute the water horizontally into the cavity volume in the form of a water mist, a minimum of 90% of the water being supplied by water drops with a diameter of less than 0.001 m.

In such cases where the fire brigade or other rescue personnel wants to enter the cavity volume and actively manually fight fires, the variant of the invention in FIG. 4 allows fire hoses to be connected to hydrants which can be installed through and be connected to the water-supply of the low-pressure water mist system throughout the entire length of the cavity.

The variant of the invention shown in FIG. 4 hereby makes possible substantial initial cost savings in connection with installation of active water-based fire protection installations in elongated cavities.

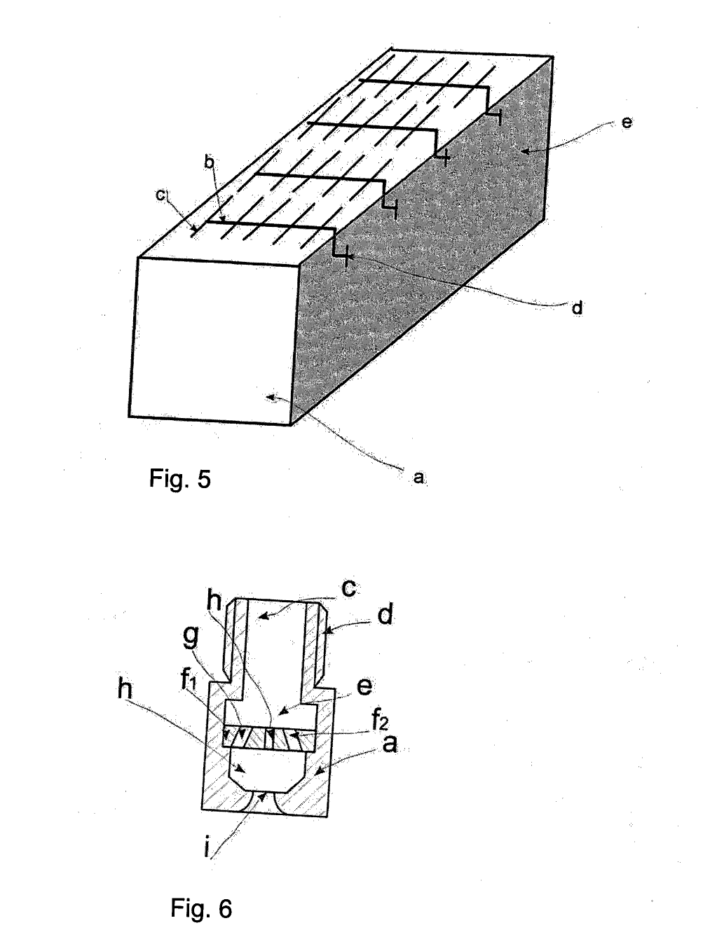

FIG. 5 shows a simple variant of the invention. The figure shows an elongated cavity in the form of a tunnel in which a sectionized low-pressure water mist system is installed, which system is characterized in that each fire section is actively fire protected by a nozzle pipe system consisting of a dry supply pipe (b) with a water supply. connection (d) disposed outside of the fire protected cavity (e), for tunnel systems optionally in a neighbouring tunnel tube, and where one or more nozzle pipes (c), on which open low-pressure water mist nozzles are mounted, are coupled to the dry supply pipe (b).

FIG. 6 shows an example of a low-pressure water mist nozzle which is part of the invention. The nozzle functions in that, at a water pressure of 10+/−6 bars, water flows in from nozzle pipes through the inlet port (C) of the nozzle and farther on into the nozzle chamber (e), which is terminated by a plate with one or more inclined openings and one or more centrally disposed openings, all with a diameter of 2 mm +/−1.5 mm. The water flows through the openings into a rotation chamber (h) where the water flows from the inclined holes make the water rotate. The water flow hereafter continues out from the rotation chamber via an opening disposed in the centre of the rotation chamber.

The rotational energy of the water jet hereafter splits the water jet into droplets, which hereafter constitute a water mist spray where at least 90% of the water is distributed in the form of water drops with drop diameters of less than 0.001 m.

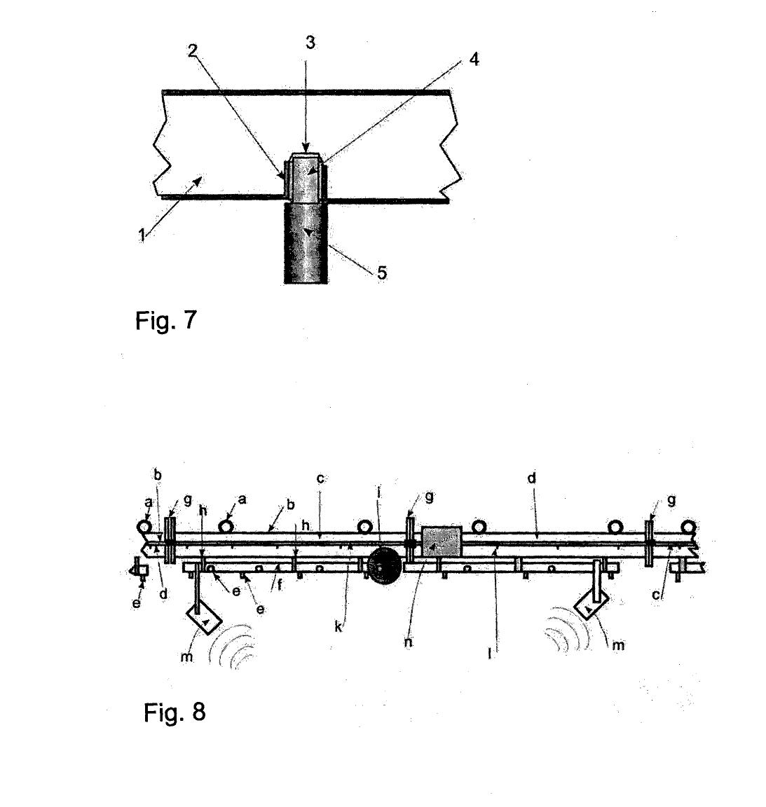

FIG. 7 shows a detail of a variant of the invention, showing an example of a nozzle pipe with mounted on low-pressure water mist nozzle, characterized in that the nozzle pipe (1) is designed with inside spot-facings with an inside opening (3) and with inside thread (4) in which a water mist nozzle (5) is mounted.

The variant of the invention allows mounting of nozzles in nozzle pipes with thread connection without use of pipe fittings, and the variant of the invention allows installation of water mist nozzles on the bottom side of pipes without getting into contact with deposits precipitated on the inner surface of nozzle pipes.

FIG. 8 shows an embodiment of the invention showing a section of intercoupled tunnel fire protection modules. The figure shows a fully mounted active tunnel module which is coupled together with a fully mounted tunnel spacer module so that these together constitute a combined active hydraulic fire extinguishing system for a tunnel fire section, and a double knock fire detecting system for fire monitoring of the tunnel fire zone and for activating active water mist system in case of fire in the tunnel zone, and for activating water supply system and pump system, and for giving off alarm in case of fire in a tunnel zone.

FIG. 8 shows a variant of the invention showing two ready mounted tunnel fire protection modules (c) and (d) for fire protection of a whole tunnel fire zone. The variant of the invention is characterized in that it consists of fully mounted tunnel protection modules consisting of active pipe modules (c) and spacer pipe modules (d) which are alternatingly mounted together to constitute an aggregate chain of tunnel protection modules with an aggregate water supply pipe extending throughout the entire length of the tunnel ceiling and where active tunnel modules (c) and spacer tunnel modules (d) in coupled together pairs constitute fire protection systems with fire announcing system and active fire extinguishing system in each of the fire protection zones of the tunnel cavity.

FIG. 8 shows that the tunnel fire protection modules (c) and (d) consist of supply pipe section (b) with flange (g) or other kind of pipe connection at both ends. On the supply pipe sections there are mounted nozzle pipes (f) where one end thereof is closed by mounted water mist nozzles (e), coupled together two and two so as together to cover the length of the tunnel pipe fire zone in the ceiling of which the modules are installed. An electrically activated zone valve (i) connects the water supply pipe (b) to the nozzle pipe (f) in each tunnel fire protection zone. For each tunnel fire protection zone there are also installed a fire detector and system activation panel (n) being electrically connected to a fire sensor system consisting of one or more temperature sensors (I), which together constitute temperature monitoring throughout the entire length of the tunnel. For each fire panel there are additionally connected two flame announcers (m) which are mounted at the ends of the two tunnel modules in each tunnel fire protection zone, from where they monitor the tunnel zone from two sides as to fire in the section.

In case of fire in the tunnel protection zone, flame announcers in the tunnel protection zone register the fire and give off a signal to the fire panel (n) installed in the tunnel protection zone in question. The fire panel hereafter gives off an addressed alarm via a bus connecting the fire panels of the tunnel fire zone, whereafter an alarm is given off. When one or more temperature sensors in the tunnel registers/register a temperature increase in the tunnel, the connected tunnel fire zone fire announcing panel or panels sends/send a signal, via a bus connection, to all zone fire announcing panels in the tunnel cavity. This makes the fire announcing panel that had registered flames in its tunnel fire protection zone accept that there is a fire in the tunnel fire protection zone in question.

1. A fire extinguishing system sectionized in sections for fire protection of elongated cavities, characterized in that it actively fights fires in one or more tunnel sections with water which is supplied to low-pressure water mist nozzles via a pipe system and which is distributed from the nozzles in the tunnel section with fire as well as its neighbouring sections in the form of a low-pressure water mist spray, a minimum of 90% of the volume of the water being distributed in drops with diameters of less than 0.001 m.

2. A fire extinguishing system according to claim 1, characterized in that the supply water pressure for the low-pressure water mist nozzles is 4-16 bars.

3. A fire extinguishing system according to claim 1, characterized by nozzle pipes made of thin-walled materials with a thickness of 1-3 mm, where the inside surfaces of said nozzle pipes comprise inside thread connections to which low-pressure water mist nozzles are coupled.

4. A fire extinguishing system according to claim 1, characterized in that the low-pressure water mist nozzles of the system are disposed offset in the longitudinal direction of the cavity on the nozzle pipes of the system.

5. A fire extinguishing system according to claim 1, characterized in that it consists of one or more interconnected pipe sections consisting of an intercoupling of finished system modules, where one or more system modules together constitute supply pipe and nozzle system for a fire protection zone in the cavity.

6. A fire extinguishing system according to claim 1, characterized in that water supply pipes for low-pressure water mist nozzles are provided with hydrant couplings for fire hoses.

7. A fire extinguishing system according to claim 1, characterized in that nozzle pipes are installed on the cavity walls and that water mist nozzles have horizontally disposed nozzle openings.

8. A fire extinguishing system according to claim 1, wherein activation of system modules is characterized by being controlled by flame announcers monitoring the fire protection sections of the cavity.

9. A fire protection system according to claim 1, characterized in that water connection for nozzle pipe sections is passed out from the fire protected cavity.

10. A fire protection system according to claim 8, characterized in that flame announcers are to register flames from a fire within a predetermined period of time before the flame announcers pass on an activation signal for activation of water mist in one or more of the fire protection zones of the cavity.

11. A fire protection system according to claim 10, characterized in that it consists of ready-assembled system modules on which, on fire protection modules for each fire protection zone, there is disposed an electronic fire announcing panel with monitoring and activation functions, which monitors electric circuits and connections in the fire protection zone and in case of activation of a flame announcer gives off alarm signal to a central control unit and activation signal to local activating nozzles for activation of water mist spray in the monitoring zone and its neighbouring zones.
